(19) United States
(12) Patent Application Publication
(10) Pub. No.: US 2023/0342707 A1
(43) Pub. Date: Oct. 26, 2023

(54) DELIVERY PLAN GENERATION

(71) Applicant: Accenture Global Solutions Limited, Dublin (IE)

(72) Inventors: Antonio Penta, Dublin (IE); Andreea-Roxana Miu, Dublin (IE); Denis Drennan, Dublin (IE); Carlos Aumente Maestro, Dublin (IE)

(21) Appl. No.: 17/729,944

(22) Filed: Apr. 26, 2022

(51) Int. Cl. G06Q 10/08

(52) U.S. Cl. CPC G06Q 10/08355

(57) ABSTRACT

The proposed systems and methods improve the generation of delivery plans by creating one or more predictive models that can evaluate the likelihood of success of delivery plans based on notable historic delivery plans. The predictive models can be applied on already clustered delivery objects, or the clustering can be applied to results of the predictive models. The output of this stage is a set of clusters of delivery objects that are the initial delivery plans. After this stage refining process(es) can be applied to the initial delivery plans to determine a final set of delivery plan candidates. By learning from successful past outcomes, the predictive models can generate initial delivery plans that have a high likelihood of successful execution. By applying refining techniques, the initial delivery plans can be narrowed down to final delivery plans that are tailored to the delivery needs of the current situation. The refining techniques can include one or more of techniques for optimizing key performance indicators, rule-based techniques, and exploratory techniques.

### TECHNICAL FIELD

The present disclosure generally relates to retail logistics, and in particular to a system and method for delivery plan generation.

### BACKGROUND

In industries involving managing inventory, there is a need for refreshing stock in some instances and for unloading overstock in other instances. For example, one store may run out of a product (e.g., articles of clothing, such as shirts and jackets) and need to replace the product supply from a warehouse. In another example, the store may run out of a product and need to replace the product supply from another store that has overstock or at least sufficient stock to give a portion of their stock to the store in need. Typically, to restock inventory, a business, such as a retailer, contacts transportation services to set up delivery of packages containing products. Arrangement of delivery services is usually done package by package. However, considering only individual packages is not always efficient for creating delivery plans in which multiple packages are delivered.

There is a need in the art for a system and method that addresses the shortcomings discussed above.

### SUMMARY

The proposed systems and methods improve the generation of delivery plans by creating predictive models that can evaluate combinations of delivery objects based on historic delivery plans that were included together in successfully executed delivery plans, creating initial delivery plans based on the results of the predictive models, and applying refining processes to the initial delivery plans to determine a final set of delivery plan candidates. In some embodiments, the refining processes include techniques for optimizing key performance indicators. In some embodiments, the refining processes additionally or alternatively include rule-based techniques. In some embodiments, the refining processes additionally or alternatively include exploratory techniques.

The predictive models can learn powerful associations. By learning from successful past outcomes, the predictive models can generate combinations of delivery objects that have a high likelihood of successful execution. The predictive models can reduce computational resources by quickly eliminating combinations of elements of a delivery plan that do not have a high likelihood of success, evaluated based on the outcome of past executed delivery plans. To further develop delivery plans, a clustering algorithm may be optionally applied to form clusters of delivery objects based on temporal or global attributes/constraints (e.g., time delivery is needed, location of delivery, product type of delivery, etc.) to provide initial delivery plan candidates either before or after the predictive models generate suitable pairs of delivery objects. In some embodiments, the clustering algorithm may be applied before running the predictive models. By optionally applying refining techniques, the initial delivery plans can be narrowed down to a set of final delivery plans that are tailored to the delivery needs of the current situation. The set of final delivery plans may include plans in which multiple types of products are combined in bundles to be delivered to one or more destinations.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method of generating a delivery plan. The computer-implemented method also includes obtaining time dependent demand information related to a product for a plurality of destinations and time dependent supply information related to the product for a plurality of origins. The method also includes creating a set of destinations from the plurality of destinations. The method also includes creating a set of origins from the plurality of origins. The method also includes generating a plurality of delivery objects each including a destination of the set of destinations, and an origin of the set of origins, and a type of product. The method also includes generating combinations of individual delivery objects of the generated plurality of delivery objects. The method also includes training a neural network on training data including a training set of historical delivery plan information to classify the combinations into a first group and a second group based on a likelihood of meeting at least one requirement. The method also includes processing the combinations of individual delivery objects through the trained neural network to classify the combinations into the first group and the second group based on a likelihood of meeting at least one requirement, where the first group includes initial delivery plan candidates. The method also includes processing the initial delivery plan candidates classified through one or more refining processes to determine a final set of delivery plan candidates. Other embodiments of this aspect include corresponding computer systems, apparatus, and computer programs recorded on one or more computer storage devices, each configured to perform the actions of the methods.

Implementations may include one or more of the following features. The method where obtaining time dependent demand information includes referring to requirement matrices corresponding to a plurality of destinations to obtain the number of units of a product needed by the respective destinations at a first time and the number of units of a product needed by the respective destinations at a second time. Obtaining time dependent supply information may include referring to capacity matrices corresponding to respective origins to obtain the number of units of a product available at the respective origins at a first time and the number of units of a product available at the respective origins at a second time. Generating a plurality of delivery objects may include determining whether the origins have enough supply of a product type to cover the demand for the same product type at a destination. The includes whether or not past executed delivery plans were executed on time or whether or not past executed delivery plans met predetermined key performance indicators. The method may include: creating clusters by applying a clustering algorithm to the initial delivery plan candidates to create intermediate delivery plan candidates. The clustering is based on spatial-temporal local and global features. Implementations of the described techniques may include hardware, a method or process, or computer software on a computer-accessible medium.

One general aspect includes a non-transitory computer-readable medium storing software may include instructions executable by one or more computers which. The non-transitory computer-readable medium storing software also includes obtain time dependent demand information related to a product for a plurality of destinations and time dependent supply information related to the product for a plurality of origins. The software also includes creating a set of destinations from the plurality of destinations. The software also includes creating a set of origins from the plurality of origins. The software also includes generating a plurality of delivery objects each including a destination of the set of destinations, and an origin of the set of origins, and a type of product. The software also includes generating combinations of individual delivery objects of the generated plurality of delivery objects. The software also includes training a neural network on training data including a training set of historical delivery plan information to classify the combinations into a first group and a second group based on a likelihood of meeting at least one requirement. The software also includes processing the combinations of individual delivery objects through the trained neural network to classify the combinations into the first group and the second group based on a likelihood of meeting at least one requirement, where the first group includes initial delivery plan candidates. The software also includes processing the initial delivery plan candidates classified through one or more refining processes to determine a final set of delivery plan candidates. Other embodiments of this aspect include corresponding computer systems, apparatus, and computer programs recorded on one or more computer storage devices, each configured to perform the actions of the methods.

Implementations may include one or more of the following features. The non-transitory computer-readable medium storing software where obtaining time dependent demand information includes referring to requirement matrices corresponding to a plurality of destinations to obtain the number of units of a product needed by the respective destinations at a first time and the number of units of a product needed by the respective destinations at a second time. Obtaining time dependent supply information may include referring to capacity matrices corresponding to respective origins to obtain the number of units of a product available at the respective origins at a first time and the number of units of a product available at the respective origins at a second time. Generating a plurality of delivery objects may include determining whether the origins have enough supply of a product type to cover the demand for the same product type at a destination. The historical delivery plan information includes whether or not past executed delivery plans were executed on time or whether or not past executed delivery plans met predetermined key performance indicators. The instructions further cause the one or more computers to create clusters by applying a clustering algorithm to the initial delivery plan candidates to create intermediate delivery plan candidates. The clustering is based on spatial-temporal local and global features. Implementations of the described techniques may include hardware, a method or process, or computer software on a computer-accessible medium.

One general aspect includes a system for generating a delivery plan. The system also includes a device processor. The system also includes a non-transitory computer readable medium storing instructions that are executable by the device processor to. The system also includes obtain time dependent demand information related to a product for a plurality of destinations and time dependent supply information related to the product for a plurality of origins. The system also includes create a set of destinations from the plurality of destinations. The system also includes create a set of origins from the plurality of origins. The system also includes generate a plurality of delivery objects each including a destination of the set of destinations, and an origin of the set of origins, and a type of product. The system also includes generate combinations of individual delivery objects of the generated plurality of delivery objects. The system also includes train a neural network on training data including a training set of historical delivery plan information to classify the combinations into a first group and a second group based on a likelihood of meeting at least one requirement. The system also includes process the combinations of individual delivery objects through the trained neural network to classify the combinations into the first group and the second group based on a likelihood of meeting at least one requirement, where the first group includes initial delivery plan candidates. The system also includes process the initial delivery plan candidates classified through one or more refining processes to determine a final set of delivery plan candidates. Other embodiments of this aspect include corresponding computer systems, apparatus, and computer programs recorded on one or more computer storage devices, each configured to perform the actions of the methods.

Implementations may include one or more of the following features. The system where obtaining time dependent supply information may include referring to capacity matrices corresponding to respective origins to obtain the number of units of a product available at the respective origins at a first time and the number of units of a product available at the respective origins at a second time. Generating a plurality of delivery objects may include determining whether the origins have enough supply of a product type to cover the demand for the same product type at a destination. The historical delivery plan information includes whether or not past executed delivery plans were executed on time or whether or not past executed delivery plans met predetermined key performance indicators. The instructions further cause the one or more computers to create clusters by applying a clustering algorithm to the initial delivery plan candidates to create intermediate delivery plan candidates. The clustering is based on spatial-temporal local and global features. Implementations of the described techniques may include hardware, a method or process, or computer software on a computer-accessible medium.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a map of warehouses and stores, according to an embodiment;

FIG. 2 is a requirement matrix, according to an embodiment;

FIG. 3 is a capacity matrix, according to an embodiment;

FIG. 4 is a stock matrix, according to an embodiment;

FIG. 5 shows a schematic diagram of a system for delivery plan generation, according to an embodiment;

FIG. 6 is a schematic diagram of an embodiment of a delivery plan management system, according to an embodiment;

FIG. 7 shows a flow of processes from the delivery object learner to components of the delivery plan generator, according to an embodiment;

FIG. 8 is a schematic diagram of an embodiment of processing the combinations of individual delivery objects through the trained neural network to classify the combinations, according to an embodiment; and

FIG. 9 shows a flowchart of a computer implemented method of generating a delivery plan, according to an embodiment.

### DESCRIPTION OF EMBODIMENTS

Managing inventory of stock often involves distributing and redistributing stock to various locations to balance the stock to a desirable level at each location. Businesses, such as retailers, may use third party logistics or transportation service providers to deliver products in packages of SKUs (Stock Keep Unit) to its stores. In many instances, the routes to deliver the packages may be out of the business's control, but the business can control how to build the packages to optimally serve its stores, and to leverage the services offered by third party logistics service providers. To optimally allocate stock, the business can build an optimal set of SKU packages for the logistics services, considering the status and the constraints of its supply chain. Thus, embodiments of the disclosed method may include obtaining the status and/or the constraints of a supply chain. An example of the status and constraints of the supply-chain could be the locations of the stores and warehouses, their requirements and capacities, the desired stock levels for each store, as well as properties and additional constraints. For example, the properties and additional constraints may be defined by third party logistics, such as the costs, time, and areas covered by the services.

As discussed in more detail below, the system and method for delivery plan generation could be integrated into a larger system automating the entire process of generating the delivery plans, accepting electronic applications from delivery (or logistics) service providers, analyzing the applications, matching service providers to delivery plans, formulating contracts for execution of the delivery plans by the matched service providers, and executing the contracts. In other words, in addition to creating the delivery plans, the larger system can include automating the interactions and procurement processes between a retailer and a logistics services provider, as well as generate optimal contracts between the actors using a controlled and iterative auction mechanism. Furthermore, the system and method for delivery plan generation may include executing the generated delivery plan or overseeing/managing the execution of the generated delivery plan by a third party.

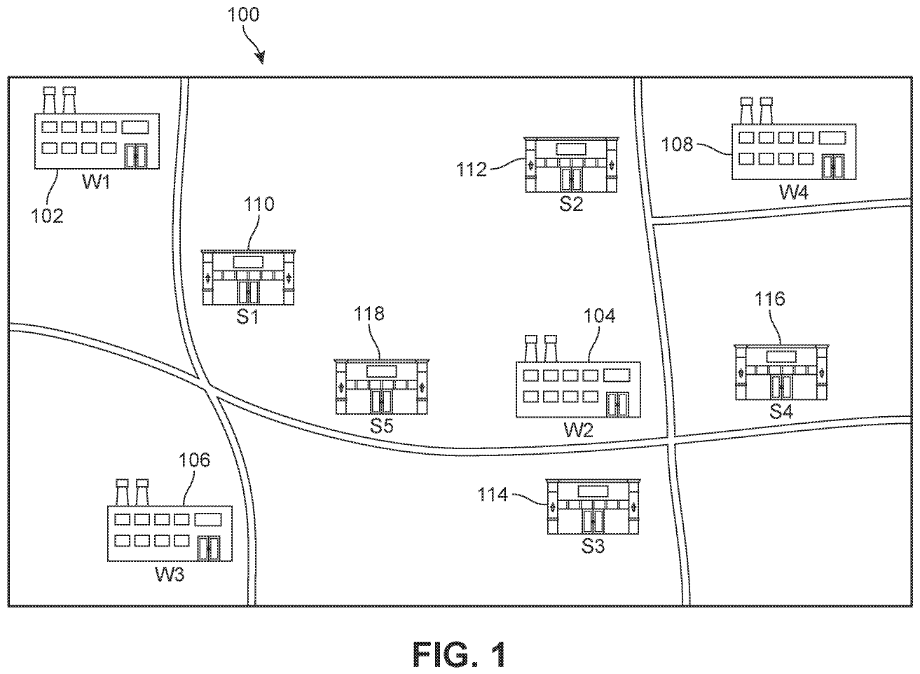

FIG. 1 is a map of warehouses w and stores s, according to an embodiment. The map shown includes warehouses: first warehouse (w₁) 102, second warehouse (w₂) 104, third warehouse (w₃) 106, and fourth warehouse (w₄) 108. The map shown includes stores: first store (s₁) 110, second store (s₂) 112, third store (s₃) 114, fourth store (s₄) 116, and fifth store (s₅) 118.

A delivery object may be identified by the following triple: (origin_id, destination_id, delivery-order_id). A package may be identified by an id named delivery-order_id. The origin_id may identify a location where the package is stored, while a destination_id may identify the location where the package needs to be delivered.

In some embodiments, an extended delivery object may be a delivery object with annotations. Examples of annotations include a lead timestamp, which refers to the time the package needs to be delivered and the number and type of SKU involved in the order.

As discussed in more detail below, a delivery plan may include various combinations of deliveries of products made to stores from warehouses and/or other stores. For example, a delivery plan may include a combination of delivery objects or extended delivery objects.

A delivery plan can contain standard or surplus delivery objects. A delivery object is defined as standard if the package is assembled in a warehouse, while a surplus delivery object is assembled in a store. For example, referring to FIG. 1, if a delivery object contains (w₁, s₁, 1), where the warehouse w₁ is the origin_id, the store s₁ is the destination_id, and 1 is the delivery-order_id, then this delivery object is a standard delivery object because the origin is a warehouse. In another example, if the delivery object is (s₁, s₂, 1), where the store s₁ is the origin_id, the store s₂ is the destination_id, and 3 is the delivery-order_id, then the delivery object is a surplus delivery object because the origin is a store.

A delivery plan can be homogeneous or heterogeneous. A delivery plan is homogenous if all its delivery objects are standard and are coming from the same warehouse. For example, referring to FIG. 1, a homogenous delivery plan could include the following delivery objects: (w₂, s₃, 1) and (w₂,s₄, 2). If the delivery plan has a mix of standard and surplus delivery objects, including different warehouses and stores, then it is called heterogeneous delivery plan. For example, referring to FIG. 1, a heterogeneous delivery plan could include the following delivery objects: (w₂, s₁, 1) and (w₁, s₂, 3).

The status and/or constraints of a supply chain at a given time may be tracked in time dependent matrices. For example, the matrices may include a requirement matrix, a cumulative capacity matrix, and a stock matrix. The columns of the requirement matrix, a cumulative capacity matrix, and a stock matrix may have a fixed positional order, which represents the time. In other words, the value in each cell (or entry) is based on a point in time assigned to each column.

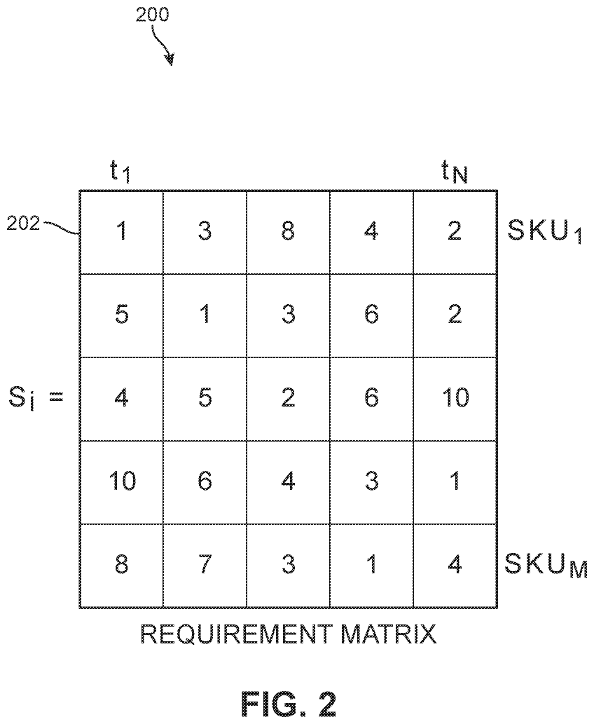

In some embodiments, stores may maintain a requirement matrix to track how much inventory the stores need at given times (e.g., t₁, t₂, . . . , t_{N}). For example, FIG. 2 shows a requirement matrix 200, according to an embodiment. In requirement matrix 200, the values of the entries are dependent on the time (e.g., t₁) assigned to each column and the SKU (e.g., SKU₁) assigned to each row. For example, cell 202, where t₁ and SKU₁ intersect, i.e. (t₁, SKU₁), shows a value of 1. This value of 1 represents the number of SKU₁ required at store i (sᵢ) at time t₁. In other words, in requirement matrix 200, each element (i, j) represents the requirement of the respective store at time j for the SKU i.

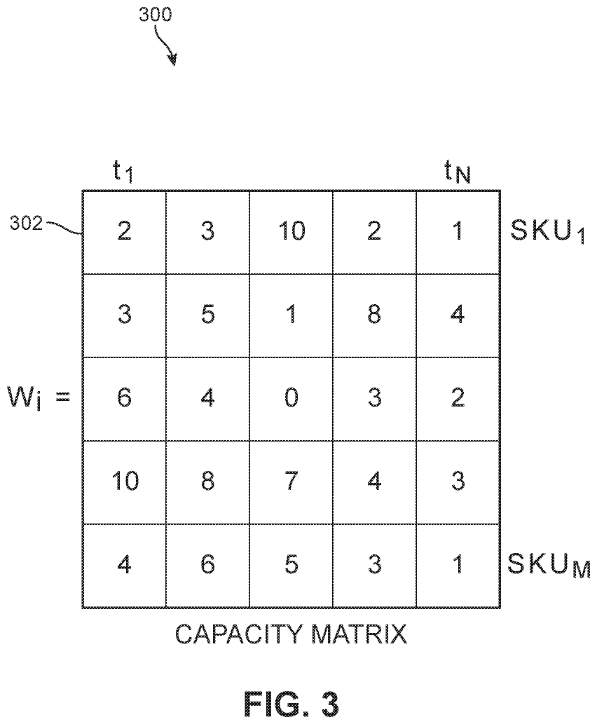

In some embodiments, warehouses may maintain a cumulative capacity matrix to track how much inventory the warehouses have at given times (e.g., t₁, t₂, . . . , t_{N}). For example, FIG. 3 shows a cumulative capacity matrix 300, according to an embodiment. In cumulative capacity matrix 300, the values of the entries are dependent on the time (e.g., t₁) assigned to each column and the SKU (e.g., SKU₁) assigned to each row. For example, cell 302, where t₁ and SKU₁ intersect, i.e. (t₁, SKU₁), shows a value of 2. This value of 2 represents the number of SKU₁ available at warehouse i (wᵢ) at time t₁. In other words, in cumulative capacity matrix 300, each element (i, j) represents the sum of the capacity of the respective warehouse at time j+the capacity at time j−1 for the SKU i.

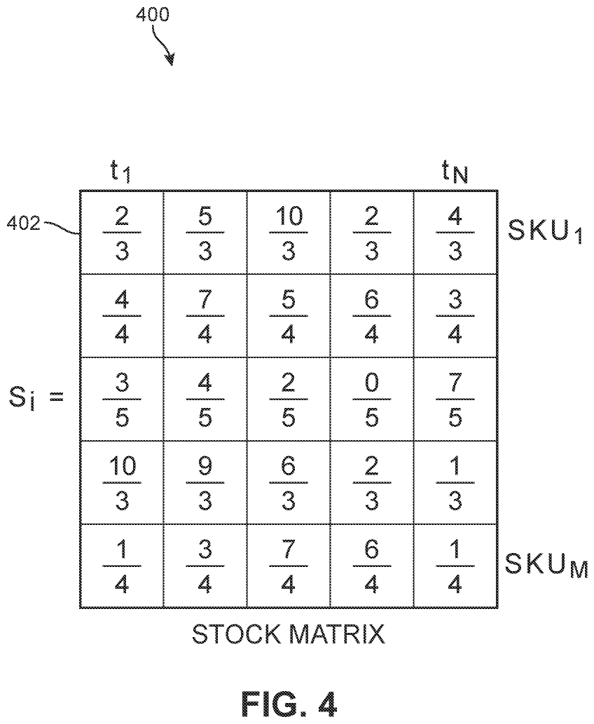

In some embodiments, stores may maintain a stock matrix to track how much inventory the stores have at given times (e.g., t₁, t₂, . . . , t_{N}). In some instances, a stock matrix may provide a ratio between a stock and safety level at given times. For example, FIG. 4 shows a stock matrix 400, according to an embodiment. In stock matrix 400, each element (i, j) represents the ratio between the stock and the safety level of a respective store at time j for the SKU i. It is possible for entries of this matrix for values j greater than the current time are 0. Stock levels represent the amount of a product the store has in its inventory. Safety levels represent the amount of a product the store would like to have in its inventory to guarantee the minimum sales to meet predefined KPIs. For example, in cell 402, where t₁ and SKU₁ intersect, i.e. (t₁, SKU₁), 2 units of product SKU₁ are in stock and 3 units of product SKU₁ are needed to guarantee the minimum sales to meet predefined KPIs for the product.

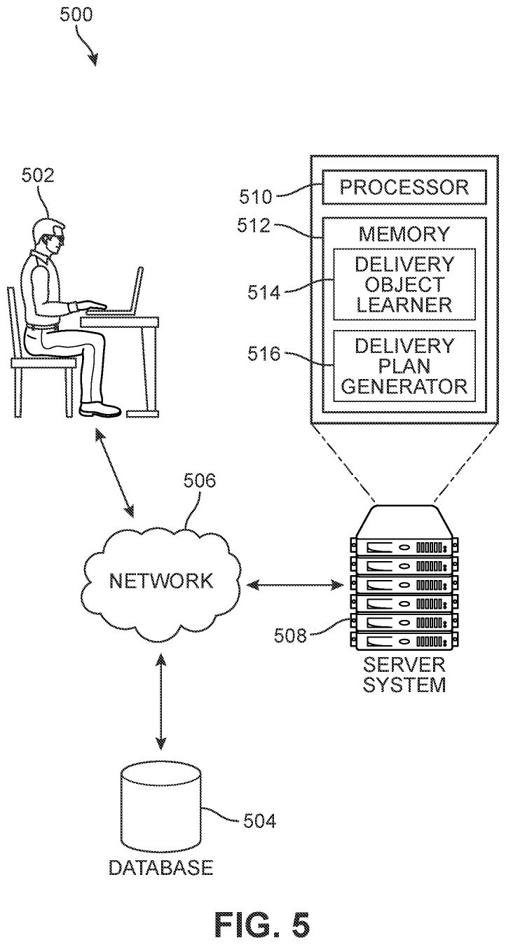

FIG. 5 shows a schematic diagram of a system for delivery plan generation 500 (or system 500), according to an embodiment. The disclosed system for delivery plan generation may include a plurality of components capable of performing the disclosed computer implemented method (e.g., method 900). For example, system 500 includes a user device 502, a computing system 508, and an application database 504. The components of system 500 can communicate with each other through a network 506. For example, user device 502 may retrieve information from application database 504 via network 506. In some embodiments, network 506 may be a wide area network (“WAN”), e.g., the Internet. In other embodiments, network 506 may be a local area network (“LAN”).

While FIG. 5 shows one user device, it is understood that one or more user devices may be used. For example, in some embodiments, the system may include three user devices. In another example, in some embodiments, 10 user devices may be used. The users may include different businesses, such as retailers or third party logistics or transportation service providers, using different devices. In some embodiments, the user devices may be computing devices used by a user. For example, user device 502 may include a tablet computer. In other examples, user device 502 may be a smart phone, a laptop computer, a desktop computer, or another type of computing device. The user devices may be used for inputting, processing, and displaying information.

As shown in FIG. 5, in some embodiments, delivery object learner 514 and delivery plan generator 516 may be hosted in a computing system 508. Computing system 508 includes a processor 510 and a memory 512. Processor 510 may include a single device processor located on a single device, or it may include multiple device processors located on one or more physical devices. Memory 512 may include any type of storage, which may be physically located on one physical device, or on multiple physical storage devices. In some cases, computing system 508 may comprise one or more servers that are used to host the delivery object learner and the delivery plan generator.

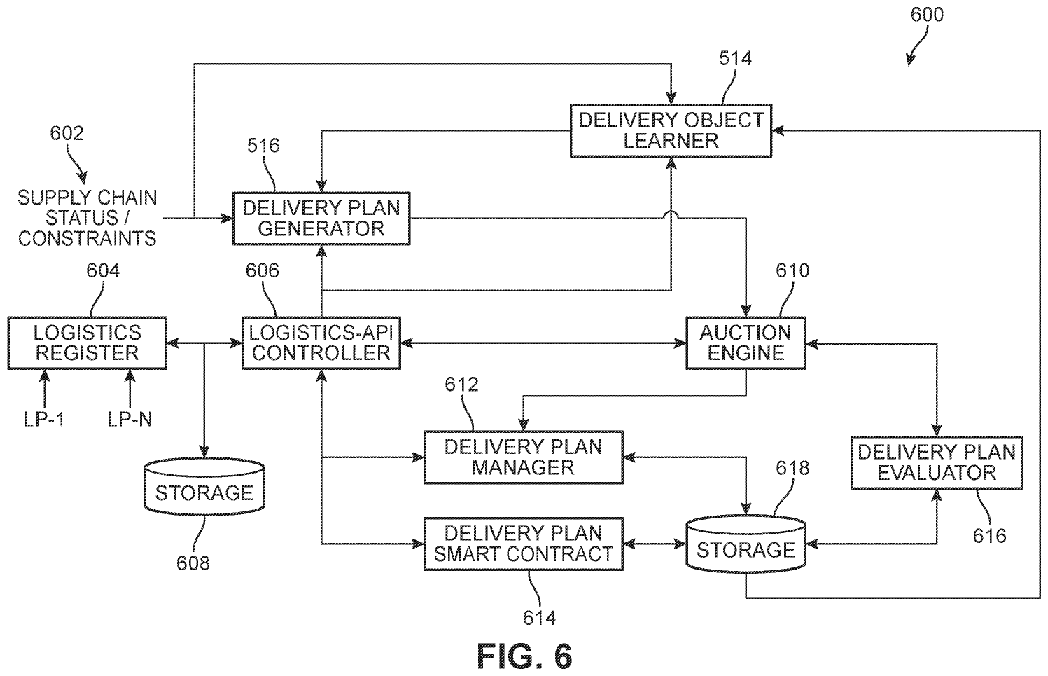

FIG. 6 is a schematic diagram of an embodiment of a delivery plan management system 600 (or system 600), according to an embodiment. FIG. 6 shows how system 500 can be incorporated into a bigger system, such as system 600. System 600 includes a system that evaluates and learns from past executed delivery plans, generates new delivery plans based on the evaluation and learning, matches companies/businesses (e.g., retailers) with delivery companies (e.g., third party logistics or transportation service providers) to execute the generated delivery plans, and generates smart contracts between the matched actors for the execution of delivery plans. Input to system 600 may include supply chain status and constraints 602, as well as registration information from service providers who are interested in executing delivery plans. Examples of supply chain status and constraints are discussed in detail above. Supply chain status and constraints 602 may be inputted into delivery plan generator 516 and delivery object learner 514, which are components of system 600 in this embodiment. As discussed in further detail below, delivery object learner 514 may generate predictive models that generate initial delivery plan candidates that may be passed to delivery plan generator 516. The predictive models can predict delivery plans that can be fine-tuned/refined by the delivery plan generator 516 to generate a set of final delivery plan candidates.

Logistics or transportation service providers interested in executing the generated delivery plans can propose their services by registering with a logistics register 604. The registration may require the logistics service provider to communicate with the business seeking execution of the delivery plan (e.g., a retailer) using a standardized set of application programming interfaces (APIs), e.g., Logistics API. Logistics-API controller 606 is component used to manage all the interaction between the actors. Examples of interactions can be the retrieval of delivery plans, all the constraints and properties of the logistics service providers, the definitions of the smart contracts, the communications of the geographical coverage constraints, and the management of the procurement process. Storage 608 may store accepted logistics service providers.

A logistics or transportation service provider can register a software agent (logistic agent) using the logistics register 604. Each agent can be used to represent a service status such as the transportation modality (e.g., car, van, bike), spatial and temporal constraints, service level, costs.

Each agent can communicate with the delivery plan management system using the standardized delivery plan management system API (not shown) that can be in communication with logistics-API controller 606, while the agent interacts with the delivery plan management system with its own internal API. Each agent can relate to an internal logistic knowledge base platform to retrieve and store information.

Auction engine 610 manages the buying and selling process of the delivery plan candidates among the registered logistics service providers. The goal of this component is to match the delivery plans to the logistics service providers considering the different offers but also other compatibility factors, such as the service reliability computed from historical data and costs. Buying and selling offers may be communicated to auction engine 610 by logistics-API controller 606. The matching may be performed by auction engine 610.

In some embodiments, the matching may include the following steps:
1) Initial Matches—Delivery plan generator 516 provides the delivery plan candidates which are initially matched with the logistic agents. Each delivery plan candidate can be matched to multiple logistic agents.
2) Bidding—In the case of multiple matches, auction engine 610 asks the logistic agents to make a bid/offer for their services.
3) Ranking—The matches are ranked based on different criteria such as delivery plan priorities, service level, costs, time, and transportation modalities.
4) Targets Check—Auction engine 610 checks if plans meet the retail targets. In the case of positive outcomes in the level check phase, the matched delivery plans are communicated to Delivery plan manager 612 otherwise the next step is triggered.
5) Negotiation—In this step, auction engine 610 and the logistics agents negotiate modifications on the status of the agent to build new matches.
6) Match—A new match step is started based on the new status updates of the logistics agent.

In some embodiments, the matching steps may include creating a bipartite graph based on the compatibility between the delivery plan and the logistics agents. The compatibility may be created if the logistic agents can deliver the plan according to its requirements. Then, the auction engine matches delivery plans to the best logistic agents considering the cost, the service level options, and the targets. For example, if the logistic agents provide ranges of costs with different service levels for each spatial-temporal area in the map, then an optimal match is searched. After initial matching, a bidding and ranking phase is put in place to create the final matches. The ranking may be formulated using the scores obtained by solving the optimal match procedure under constraints.

Delivery plan manager 612 manages the procurement between the delivery plans and the logistics service providers. The outputs are the accepted delivery plan that will be tasked to the logistics service providers. Delivery plan evaluator 616 monitors the execution of delivery plans evaluating which delivery plan are executed on time, whether or not past executed delivery plans met predetermined key performance indicators, and if any problem may be in the next horizon, such as stock-out events and/or overspend due to the overstock. The horizon may be any length of time, for example, the next day or the next few weeks.

Storage 618 may store selected delivery plans, as well as information related to the execution of delivery plans (e.g., evaluation information), which may be provided by or retrieved by delivery plan manager 612, delivery object learner 514, delivery plan smart contract 614, auction engine 610, and delivery plan evaluator 616.

Delivery plan smart contract 614 manages the creation of smart contracts between logistics service providers and the retails on the matched Delivery Plans. Delivery plan smart contract 614 certifies the agreements among the actors including factors such as the costs, service levels, and penalties for delivering the delivery plan. The contracts can be certified using a blockchain-based ecosystem.

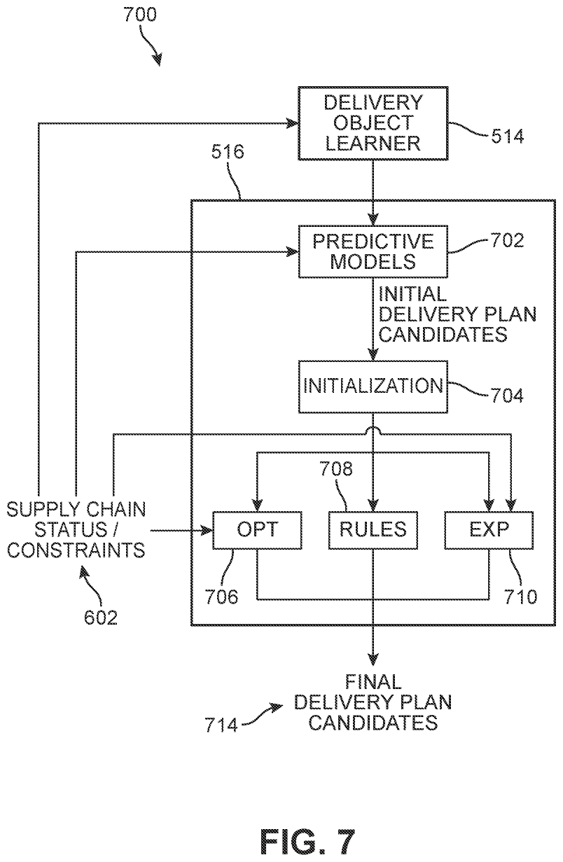

FIG. 7 shows a flow of processes from the delivery object learner 514 to components of delivery plan generator 516, according to an embodiment. Delivery object learner 514 can create one or more predictive models 702 (or predictive models 702 or neural networks 702) from historical data using the annotations provided by delivery plan evaluator 616. For example, in some embodiments, delivery object learner 514 may perform operation 912. Predictive models are sometimes herein referred to as “prediction models” or “neural networks.” Predictive models may include one or more predictive models. Predictive models 702 may generate initial delivery plan candidates that may be initialized at initialization 704. In some embodiments, the initial delivery plan candidates may be passed to one or more fine-tuning modules, including optimization module 706, rules module 708, and exploration module 710 for fine-tuning to generate a set of final delivery plan candidates. In some embodiments, delivery plan generator 516 may perform operations 914 and 916. In some embodiments, the initial delivery plan candidates output by predictive models 702 may be moved forward as a set of final delivery plan candidates without undergoing fine-tuning by the fine-tuning modules. After generating a set of final delivery plan candidates, the method may further include selecting one or more delivery plan candidates of the set of final delivery plan candidates as the final delivery plan(s). The method may include executing the final delivery plan(s). For example, in some embodiments, the method may include a retailer using its own resources to execute the final delivery plan(s). In another example, a retailer may commission a third party (e.g., third party logistics service provider) to execute the final delivery plan(s). In such a case, the retailer may oversee/manage the execution. In some embodiments, a retailer may select a third party to engage in a contract with, as described with respect to FIG. 6, and may oversee/manage the execution of the final delivery plan(s).

Supply chain status and constraints 602 may be input into delivery object learner 514, predictive models 702, and the fine-tuning modules (e.g., optimization module 706, rules module 708, and exploration module 710). Delivery object learner 514 may use the supply chain status and constraints 602 to generate predictive models 702. For example, delivery object learner 514 may consider how the supply chain status and constraints 602 impact which origins and destinations can work together to distribute products in a manner that meets the requirements of the destinations in a way that is feasible with the supply of the origins. Predictive models 702 may use supply chain status and constraints 602 to generate initial delivery plan candidates. For example, supply chain status and constraints 602 may be factors that determine how delivery plans are classified as part of the same delivery plan. The fine-tuning modules may use supply chain status and constraints 602 to fine tune the initial delivery plan candidates to generate a set of final delivery plan candidates. For example, the fine-tuning modules may consider supply chain status and constraints 602 as parts of rules, as optimization constraints, and/or as parameters affecting optimization objectives.

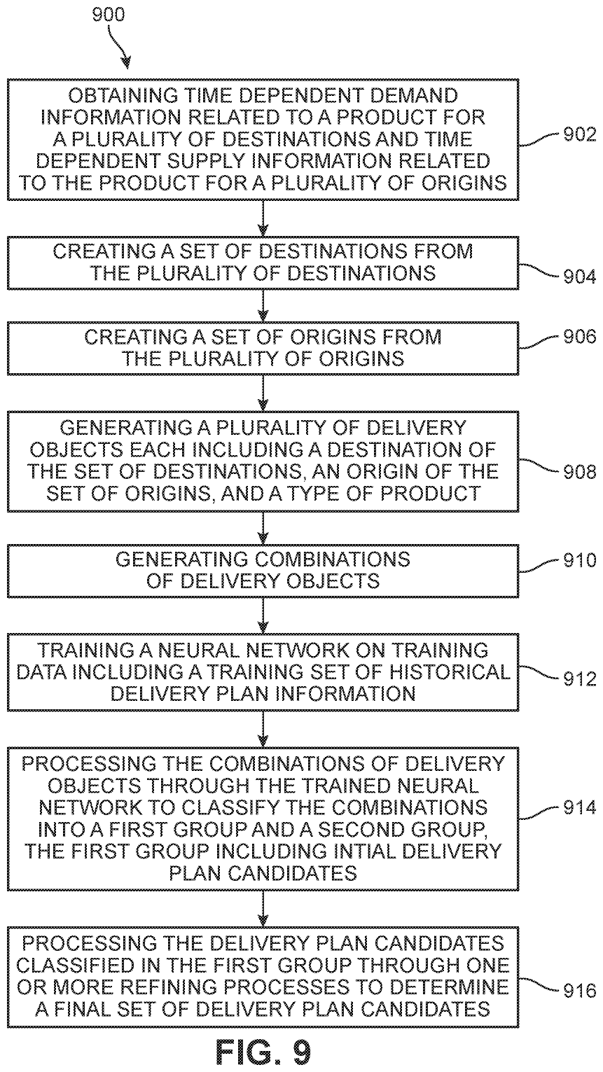

FIG. 9 shows a flowchart of a computer implemented method of generating a delivery plan, according to an embodiment. Method 900 includes obtaining time dependent demand information related to a product for a plurality of destinations and time dependent supply information related to the product for a plurality of origins (operation 902).

Method 900 includes creating a set of destinations from the plurality of destinations (operation 904). Method 900 includes creating a set of origins from the plurality of origins (operation 906).

Method 900 includes generating a plurality of delivery objects each including a destination of the set of destinations, and an origin of the set of origins, and a type of product (operation 908).

Method 900 includes generating combinations of individual delivery objects of the generated plurality of delivery objects (operation 910)

Method 900 includes training a neural network on training data including a training set of historical delivery plan information (operation 912). This training may include training to classify the combinations into a first group and a second group based on a likelihood of meeting at least one requirement.

Method 900 includes processing the combinations of individual delivery objects through the trained neural network to classify the combinations into a first group and a second group based on a likelihood of meeting at least one requirement, wherein the first group includes initial delivery plan candidates (operation 914).

Method 900 includes processing the initial delivery plan candidates through one or more refining processes to determine a final set of delivery plan candidates (operation 916). The exemplary operations of method 900 are discussed in more detail below.

In some embodiments, the method may include obtaining time dependent demand information related to a product for a plurality of destinations. For example, operation 902 includes this function. In some embodiments, time dependent demand information may include the need for a product in a plurality of stores. In many situations, the demand of a destination (e.g., a store or other marketplace) may be the cause for moving products, as the products are moved in these situations to fill the demand for the destination. In some embodiments, the destinations may be stores. In some embodiments, the time dependent demand information may be obtained from requirement matrices for particular destinations. For example, in some embodiments, the method may include referring to requirement matrices corresponding to a plurality of destinations to obtain the number of units of a product needed by the respective destinations at a first time and the number of units of a product needed by the respective destinations at a second time. In some embodiments, the second time may be a predetermined interval of time after the first time.

In some embodiments, the method may include obtaining time dependent supply information related to the product for a plurality of origins. For example, operation 902 includes this function. In some embodiments, the origins may be warehouses. In some embodiments, the origins may be additionally or alternatively stores. For example, from time to time, stores have overstock that can be redistributed to other stores. In some embodiments, time dependent supply information may include time dependent supply levels for a plurality of origins. For example, time dependent supply information may include time dependent supply levels of a product for a plurality of warehouses. In some embodiments, the method may include referring to capacity matrices corresponding to respective origins (e.g., warehouses) to obtain the number of units of a product available (i.e., capacity) at the respective origins at a first time (e.g., t₁) and the number of units of a product available at the respective origins at a second time (e.g., t_{N}) that is a predetermined length of time after the first time. In some embodiments, the second time may be a predetermined interval of time after the first time. In some embodiments, the first time and the second time related to obtaining time dependent supply information may include the same first time and second time related to obtaining time dependent demand information. Demand information can help clarify needs and supply information may help clarify potential ways that demand may be met. Evaluating supply and demand at particular points in time (e.g., the first time and the second time) can determine whether different combinations of origins and destinations are compatible for an exchange of products.

In some embodiments, obtaining time dependent supply information related to the product for a plurality of origins may include referring to stock matrices corresponding to respective origins (e.g., stores) to obtain the number of units of a product available at the respective origins at a first time and the number of units of a product available at the respective origins at a second time. In some embodiments, obtaining time dependent supply information related to the product for a plurality of origins may also include obtaining ratios between stock (or supply) and safety levels for a product at the respective origins at a first time and the number of units of a product available at the respective origins at a second time. Considering the ratio between stock and safety levels at an origin can help determine whether the origin can sacrifice a certain level of supply without going below the safety level. The additional factor of the ratio between stock and safety levels of origins can be evaluated along with the demand of destinations to determine whether different combinations of origins and destinations are compatible for an exchange of products.

The method may include creating a set of destinations. For example, operation 904 includes this function. In some embodiments, creating a set of destinations may include selecting destinations based on the time dependent demand information. For example, in some embodiments, the set of destinations may be selected based on how many units of a product are needed at a predetermined time, according to the requirement matrices of the respective destinations. In some embodiments, creating a set of destinations may include randomly selecting destinations. In some embodiments, creating a set of destinations D may include retrieving stores and their related demands in an interval (t, t+T) by accessing the stores' requirement matrices. In some embodiments, the dependent demand information related to the product for a set of destinations may be obtained before the set of destinations are created. In other embodiments, the dependent demand information related to the product for a set of destinations may be obtained after the set of destinations are created.

The method may include creating a set of origins. For example, operation 906 includes this function. In some embodiments, creating a set of origins may include selecting origins based on the time dependent supply information. For example, in some embodiments, the set of origins may be selected based on how many units of a product are available at a predetermined time, according to the capacity matrices of the respective origins. In another example, in some embodiments, the set of origins may be selected based on how many units of a product are available at a predetermined time, according to the stock matrices of the respective origins. The selecting a set of origins may include selecting origins that have a sufficient number of products (or units of products) to cover the demand of a destination. For example, according to a requirement matrix, a destination may require 7 units of a product at time t and, according to a capacity matrix, an origin may have a supply, at time t, of at least 7 units of a product, which can be transferred from the origin to the destination. Thus, this destination and origin may be selected as a pair. In some embodiments, creating a set of origins may include randomly selecting origins. In some embodiments, creating a set of origins O may include retrieving stores/warehouses and their related stock level/capacity (respectively) at time t by accessing the stores'/warehouses' stock/capacity matrices (respectively). In some embodiments, the time interval may be selected based on available services for transporting goods, e.g., third party logistics service providers, and/or the time interval of the set of destinations. In some embodiments, the dependent supply information related to the product for a set of origins may be obtained before the set of destinations are created. In some embodiments, the dependent supply information related to the product for a set of origins may be obtained after the set of origins are created.

The method many include generating a plurality of delivery objects each including a destination of the set of destinations, an origin of the set of origins, and a type of product. For example, operation 908 includes this function. In some embodiments, the origins may include warehouses or stores.

Referring to FIG. 1, an example of a delivery object may include an origin of second warehouse (w₂) 104 and a destination of fourth store (s₄) 116, as well as a particular type of product for delivery (e.g., jeans). The type of product may be identified by an SKU. In another example, referring to FIG. 1, a delivery object may include an origin of fourth warehouse (w₄) 108 and a destination of second store (s₂) 112, as well as a particular type of product for delivery.

In some embodiments, the delivery objects may be generated by selecting destinations and origins based upon the demand of a predetermined product at a predetermined time at the destination and the supply of the same predetermined product at the same predetermined time at the origin. Generating delivery objects may base combinations on the time dependent demand information of destinations and the time dependent supply information of origins. For example, the delivery objects may be generated include determining whether the origins have enough supply/stock of a product type to cover the demand for the same product type at a destination and considering this determination as a factor in generating the delivery objects. In some embodiments, the delivery objects may be generated by solving an allocation problem using any known optimization model in the supply chain industry. For example, some optimization models may use requirements provided in the above-described matrices and spatial temporal constraints to find the optimal delivery objects.

In some embodiments, the delivery objects may be represented as extended delivery objects formatted in sets as follows: (x, y, w, t_k), where the demand of the SKU (w) at time t_k from demand y in the destination D can be covered at time t by the supply (e.g., capacity or stock) of x belonging to origin O. In other words, the extended delivery objects may be structured as (origin, destination, product type, delivery time).

The method may include generating combinations of individual delivery objects of the generated plurality of delivery objects. For example, operation 910 includes this function. As mentioned above, the delivery objects may be represented as extended delivery objects. Thus, generating combinations of individual delivery objects of the generated plurality of extended delivery objects may include generating combinations of individual extended delivery objects of the generated plurality of extended delivery objects.

In some embodiments, the combination of individual delivery objects may include one origin, one destination, and multiple product types. For example, referring to FIG. 1, a combination may include an origin of second warehouse (w₂) 104, destination of third store (s₃) 114, a first product type (e.g., shirts), and a second product type (e.g., pants). A delivery containing such a combination could bundle together the first product type and the second product type together for delivery to the destination. In some embodiments, the combination of individual delivery objects may include one origin, multiple destinations, and a single product type. For example, a combination may include an origin of second warehouse (w₂) 104, destinations of fourth store (s₄) 116 and third store (s₃) 114, and a single product type (e.g., jackets). In some embodiments, the combination of individual delivery objects may include one origin, multiple destinations, and multiple product types. For example, a combination may include an origin of second warehouse (w₂) 104, destinations of fourth store (s₄) 116 and third store (s₃) 114, a first product type (e.g., shirts), and a second product type (e.g., pants).

The method may include training a neural network on training data including a training set of historical delivery plan information to classify the combinations into a first group and a second group based on a likelihood of meeting at least one requirement. For example, operation 912 includes this function. Delivery object learner 514 may create one more predictive models from historical data using the annotations provided by delivery plan evaluator 616. For example, in some embodiments, the historical data may include annotated versions of delivery plans executed in the past. The annotations may be related to whether the execution of the delivery plans met predetermined requirements (e.g., delivered on time) and/or key performance indicators. In some embodiments, supply chain status and constraints 602 may be inputted to delivery object learner 514 to influence the generation of predictive models 702.

Generating one or more predictive models by delivery object learner 514 may include training a neural network on training data including a training set of historical delivery plan information to classify the combinations into a first group and a second group based on a likelihood of meeting at least one requirement. In some embodiments, the historical delivery plan information used to train the neural network may include past executed delivery plans and information related to the same delivery plans. For example, in some embodiments, the past executed delivery plans may each be formatted as delivery objects including a triple of origin, destination, and a delivery order (package) identifier. In some embodiments, the information related to the delivery plans may include whether or not the delivery objects were delivered on time. Additionally or alternatively, in some embodiments, the information related to the delivery plans may include whether or not the delivery objects were delivered in a way that met one or more predetermined key performance indicators (KPIs). For example, a predetermined KPI may include stock levels. In another example, a predetermined KPI may include a positive margin. In some embodiments, the neural network may be trained on multiple tasks. For example, the tasks may include whether or not the past delivery plans were executed on time. In another example, the tasks may include whether one or more KPIs were met by the executed past delivery plans. The tasks can be related to evaluating if two delivery objects input into the neural network can be part of the same delivery plan. Other tasks may be related to predicting the properties of the input delivery objects, such as both being urgent deliveries.

The method may include processing the combinations of individual delivery objects (e.g., pairs of delivery objects) through the trained neural network to classify the combinations into a first group and a second group based on a likelihood of meeting at least one requirement, wherein the first group includes initial delivery plan candidates. For example, operation 914 may include this function. Prediction models 702 may be used to predict if two elements (e.g., delivery objects) can be part of a delivery plan or not. In other words, prediction models 702 may do a pairwise comparison of delivery objects (or optionally extended delivery objects) to determine which delivery objects can be combined in a delivery plan. Prediction models 702 may output a probabilistic binary prediction: first group or second group. In some embodiments, the first group may include pairs of delivery objects (or optionally extended delivery objects) that meet predetermined criteria (e.g., likelihood of meeting at least one requirement, such as supply and/or demand requirements, or at least one key performance indicator). For example, the first group may include pairs of delivery objects that were previously part of a historic delivery plan that was successfully executed (i.e., execution met predetermined criteria). In some embodiments, the second group may include pairs of delivery objects that do not meet predetermined criteria. For example, the second group may include delivery objects that were previously part of a historic delivery plan that was unsuccessfully executed (i.e., execution did not meet predetermined criteria) or failed to be executed. The term “initial delivery plan candidates” can include combinations of delivery objects (e.g., pairs of delivery objects) that the prediction models evaluate as suitable combinations. The term “initial delivery plan candidates” can include suitable delivery plans, but it can also imply that a combination of delivery objects is suitable together and this information can be used while determining which delivery objects should be combined into a bigger group forming a delivery plan. In other words, “initial delivery plan candidates” can be used to describe two delivery objects that are suitable together in the same delivery plan and these two delivery objects may be combined with further delivery objects in a final delivery plan.

Prediction models 702 may provide which pairs of delivery objects have a high likelihood of success (based on predetermined criteria, e.g., including threshold probabilities) and, therefore, should work well together in a delivery plan including the pair of delivery plan objects by themselves or in combination with other delivery objects. For example, multiple pairs may be included in the first group. This grouping helps determine which pairs can be in the same delivery plan to help with creating delivery plans, but does not necessarily mean that the pairs must be in the same delivery plan. In some embodiments, the plurality of pairs may be processed through the fine-tuning techniques discussed below to group multiple pairs together to create bigger delivery plans. For example, given a set of 3 delivery objects (a, b, c), the input to prediction models 702 is (a, b), then (a, c), then (b, c). Prediction models 702 predict that (a, b) can be in the same group, and is, thus, in the first group. Prediction models 702 predict that (b, c) is in the same group, and is, thus, in the first group. Prediction models 702 can predicts that (a, c) cannot be part of the same group, and is, thus, in the second group. This prediction step yields two initial delivery plans made by (a, b) and (b, c), and also “a non-delivery plan” (a, c). These couples can be grouped to create a set of delivery plans by the fine-tuning techniques. The fine-tuning techniques can also be informed that (a, c) cannot be part of the same delivery plan. If the neural network output an empty solution, the rules and exploration modules can create a list of initial solutions even if some of them are violating the indication (predictions) of the neural network.

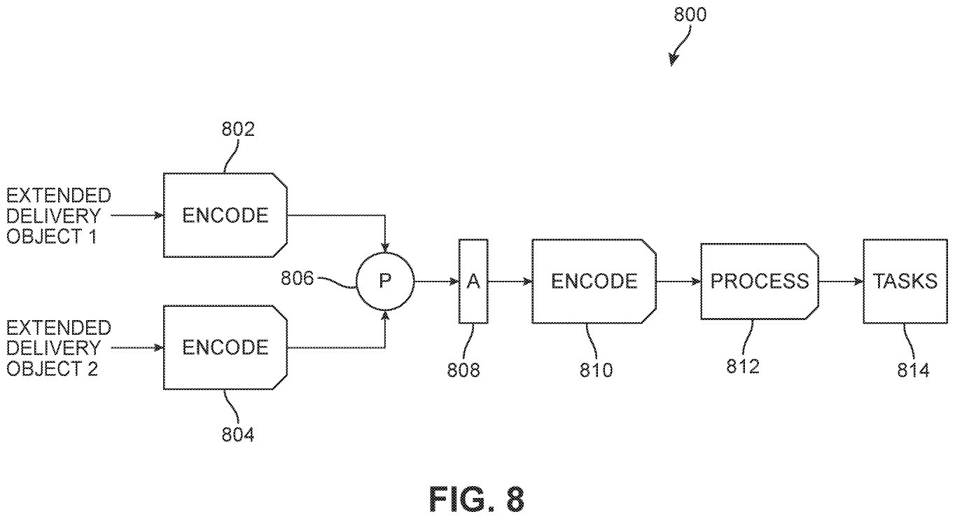

FIG. 8 is a schematic diagram of an embodiment of processing the combinations of individual delivery objects through the trained neural network to classify the individual delivery objects of the combinations or the combinations themselves, according to an embodiment. In some embodiments, processing the combinations of delivery objects through the trained neural network may include encoding the delivery objects in arrays (i.e., arrays representative of the respective delivery objects) using differentiable parametric transformation. For example, FIG. 8 shows an extended delivery object 1 being encoded into an array at 802 and extended delivery object 2 being encoded into an array at 804. The resulting arrays may be combined using an operator P 806 which is invariant to the permutation to obtain a new array A 808. Array A 808 may be further encoded at 810 and then processed at process 812 to solve multiple tasks 814. In this differential program, the encoders and process blocks are parametric differential modules. Each task may have a differentiable loss function used to train the parameters using back-propagation algorithm.

The parameters of the encoders and the process in the embodiment shown in FIG. 8 are trained using the data collected from the historical delivery plans. The delivery objects classified in the first group include features of delivery objects that were evaluated positively by delivery plan evaluator 616. For example, the first group label can express the fact that two delivery objects were part of a delivery plan that was successfully completed, and/or where various business KPIs reached target values. Examples of business KPIs include stock levels and the positive margin. In the case of multiple annotations (e.g., multiple KPIs or requirements), multiple tasks can be used to train the neural network. In some embodiments, the output of the prediction model may be normalized to help distinguish which class (e.g., first group or second group) each delivery object falls into. In some embodiments, the extended delivery objects selected are those in which the total demand prediction is greater than the total capacity or the stock level of the origins chosen in the extended delivery objects.

In some embodiments, the method may include creating groups from delivery objects and/or delivery plans that are classified as the first group by prediction models 702 to create intermediate delivery plan candidates. The grouping can be based on a clustering algorithm, such as density-based spatial clustering of applications with noise (DBSCAN), k-means clustering, or Gaussian mixture models. The clustering algorithm can output both partition-based or overlapped clusters. The grouping procedure (i.e., clustering) may be based on spatial-temporal local and global features. For example, clustering delivery objects based on spatial and temporal features may include clustering delivery objects that are closer in time and space to one another. In other words, clustering delivery objects that need to be delivered at close together times or close together places. In another example, clustering delivery objects based on global features may include clustering delivery objects including the same type of products or same type of stores/warehouses. In some embodiments, local features may be extracted using the temporal and spatial attributes/constraints assigned to elements of the destination and the origin, while the global features are related to geographical and temporal attributes assigned to segments provided by the logistic service providers.

In some embodiments, spatial features may include the positions of origins or destinations. For example, spatial features may include whether the positions of origins or destinations are close to main roads or have parking areas in close proximity to the respective origins or destinations. Examples of temporal features may include the days with high demand, the closing days, the shop hours, and the demand at a given time. Global Features can include the type of store (e.g., small or large), if the store is located within a shopping center, or if the store is critical for showcase products. Global features may additionally include the size of warehouses or the average number of stores supplied by the warehouse.

Each cluster can be a potential delivery plan and the neural networks can confirm whether or not the delivery objects can be part of the same initial delivery plan. For example, if given a set {1,2,3,4,5,6} of delivery objects, the following clusters are determined through clustering: (1,3,4,6), (1,2,5), (1,4,2), and the neural network predicts that (1,3) cannot be in the same delivery plan and (4,2) cannot be in the same delivery plan, then the initial delivery plans can be (1,4,6), (1,2,5) and (3). These initial delivery plans can be further optimized and changed by the next stages (optimization, rules, and exploration) or these initial delivery plans can be used as is.

The clustering algorithm may produce a set of clusters. Each element of the cluster may be an extended delivery object. Therefore, each cluster may define a delivery plan candidate.

In some embodiments, the clustering algorithm may be applied after generating a plurality of delivery objects (e.g., operation 908) and before processing combinations of delivery objects through the trained neural network (e.g., operation 914). For example, a set of delivery objects generated during operation 908 can be clustered using the clustering algorithm. Each cluster produced from applying the clustering algorithm can be a potential delivery plan. After producing these potential delivery plans, the neural network(s) can confirm whether pairs of delivery objects included in the delivery plan can be part of the same initial delivery plan. For example, a set {1,2,3,4,5,6} of delivery objects may yield the following clusters: (1,3,4,6), (1,2,5), (1,4,2). The clusters can overlap. Then the neural network can predict if two delivery objects can be in the same delivery plan. For example, the neural network can predict that (1,3) is not a suitable combination and (4,2) is also not a suitable combination. Based on this result, the initial delivery plans may include the following: (1,4,6); (1,2,5); and (3). These initial delivery plans can be further optimized and changed by the refining/fine-tuning techniques (e.g., optimization, rules, and exploration) discussed below.

The method may include processing the initial delivery plan candidates through one or more refining processes to determine a final set of delivery plan candidates. For example, operation 916 may perform this function. The refining techniques can include one or more of optimizing techniques, rule-based techniques, and exploratory techniques. In some embodiments, the method may include processing the intermediate delivery plan candidates through one or more refining processes to determine a final set of delivery plan candidates. In some embodiments, the refining processes may be selected automatically based upon predetermined criteria. In other embodiments, the refining processes may be manually selected. Creating initial delivery plan candidates before applying any refining techniques can reduce the computational resources needed to find a delivery plan using the refining processes from scratch (i.e., without the initial delivery plan candidates as a starting point).

The optimization techniques may include approximate or exact constraints-based optimization techniques. Optimization techniques may include adjusting parameters of delivery plans to optimize KPIs. For example, products (e.g., packages) may be included in the same bundle if they come from an origin (e.g., warehouse or store) within a 5 km radius of the destination. In this example, the parameter of 5 km radius of the destination may help optimize a KPI defined by the business selling the products.

A rule or heuristics-based technique may include a set of rules based on business knowledge. For example, a rule may dictate that packages that are to be delivered to store 1 and store 2 should be in same delivery plan.

An exploration technique may include altering or tweaking past executed delivery plans in controlled or random variations. This technique may involve introducing noise. For example, past executed delivery plans may have been successful including product 1 (e.g., shirts) and product 2 (e.g., jeans) in the same delivery plan. Altering this plan may involve adding product 3 (e.g., jackets) to the bundle to experiment with how this alteration affects performance of the delivery plan.

The objective functions used for optimization may include the following non-limiting examples: minimizing the transportation requests; maximizing the capacity of each vehicle; minimizing costs (e.g., related to transportation, set-up, storing costs), and minimizing lead time. These objective functions may be subject to the following non-limiting examples of status/constraints: SKU demand from stores, SKU Stock levels in stores, SKU capacity at warehouses, and third-party logistics service provider constraints.

The methods, devices, processing, circuitry, and logic described above may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways.

Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

We claim:

1. A computer-implemented method of generating a delivery plan, the method comprising:
obtaining time dependent demand information related to a product for a plurality of destinations and time dependent supply information related to the product for a plurality of origins;
creating a set of destinations from the plurality of destinations;
creating a set of origins from the plurality of origins;
generating a plurality of delivery objects each including a destination of the set of destinations, and an origin of the set of origins, and a type of product;
generating combinations of individual delivery objects of the generated plurality of delivery objects;
training a neural network on training data including a training set of historical delivery plan information to classify the combinations into a first group and a second group based on a likelihood of meeting at least one requirement;
processing the combinations of individual delivery objects through the trained neural network to classify the combinations into the first group and the second group based on a likelihood of meeting at least one requirement, wherein the first group includes initial delivery plan candidates; and
processing the initial delivery plan candidates classified through one or more refining processes to determine a final set of delivery plan candidates.

2. The method of claim 1, wherein obtaining time dependent demand information includes referring to requirement matrices corresponding to a plurality of destinations to obtain the number of units of a product needed by the respective destinations at a first time and the number of units of a product needed by the respective destinations at a second time.

3. The method of claim 1, wherein obtaining time dependent supply information may include referring to capacity matrices corresponding to respective origins to obtain the number of units of a product available at the respective origins at a first time and the number of units of a product available at the respective origins at a second time.

4. The method of claim 1, wherein generating a plurality of delivery objects may include determining whether the origins have enough supply of a product type to cover the demand for the same product type at a destination.

5. The method of claim 1, wherein the historical delivery plan information includes whether or not past executed delivery plans were executed on time or whether or not past executed delivery plans met predetermined key performance indicators.

6. The method of claim 1, further comprising:
creating clusters by applying a clustering algorithm to the initial delivery plan candidates to create intermediate delivery plan candidates.

7. The method of claim 1, further comprising selecting at least one delivery plan candidate of the set of final delivery plan candidates as the final delivery plan and executing the final delivery plan.

8. A non-transitory computer-readable medium storing software comprising instructions executable by one or more computers which, upon such execution, cause the one or more computers to:
obtain time dependent demand information related to a product for a plurality of destinations and time dependent supply information related to the product for a plurality of origins;
create a set of destinations from the plurality of destinations;
create a set of origins from the plurality of origins;
generate a plurality of delivery objects each including a destination of the set of destinations, and an origin of the set of origins, and a type of product;
generate combinations of individual delivery objects of the generated plurality of delivery objects;
train a neural network on training data including a training set of historical delivery plan information to classify the combinations into a first group and a second group based on a likelihood of meeting at least one requirement;
process the combinations of individual delivery objects through the trained neural network to classify the combinations into the first group and the second group based on a likelihood of meeting at least one requirement, wherein the first group includes initial delivery plan candidates; and
process the initial delivery plan candidates classified through one or more refining processes to determine a final set of delivery plan candidates.

9. The non-transitory computer-readable medium storing software of claim 8, wherein obtaining time dependent demand information includes referring to requirement matrices corresponding to a plurality of destinations to obtain the number of units of a product needed by the respective destinations at a first time and the number of units of a product needed by the respective destinations at a second time.

10. The non-transitory computer-readable medium storing software of claim 8, wherein obtaining time dependent supply information may include referring to capacity matrices corresponding to respective origins to obtain the number of units of a product available at the respective origins at a first time and the number of units of a product available at the respective origins at a second time.

11. The non-transitory computer-readable medium storing software of claim 8, wherein generating a plurality of delivery objects may include determining whether the origins have enough supply of a product type to cover the demand for the same product type at a destination.

12. The non-transitory computer-readable medium storing software of claim 8, wherein the historical delivery plan information includes whether or not past executed delivery plans were executed on time or whether or not past executed delivery plans met predetermined key performance indicators.

13. The non-transitory computer-readable medium storing software of claim 8, wherein the instructions further cause the one or more computers to create clusters by applying a clustering algorithm to the initial delivery plan candidates to create intermediate delivery plan candidates.

14. The non-transitory computer-readable medium storing software of claim 13, wherein the clustering is based on spatial-temporal local and global features.

15. A system for generating a delivery plan, the system comprising:
a device processor; and
a non-transitory computer readable medium storing instructions that are executable by the device processor to:
obtain time dependent demand information related to a product for a plurality of destinations and time dependent supply information related to the product for a plurality of origins;
create a set of destinations from the plurality of destinations;
create a set of origins from the plurality of origins;
generate a plurality of delivery objects each including a destination of the set of destinations, and an origin of the set of origins, and a type of product;
generate combinations of individual delivery objects of the generated plurality of delivery objects;
train a neural network on training data including a training set of historical delivery plan information to classify the combinations into a first group and a second group based on a likelihood of meeting at least one requirement;
process the combinations of individual delivery objects through the trained neural network to classify the combinations into the first group and the second group based on a likelihood of meeting at least one requirement, wherein the first group includes initial delivery plan candidates; and
process the initial delivery plan candidates classified through one or more refining processes to determine a final set of delivery plan candidates.

16. The system of claim 15, wherein obtaining time dependent supply information may include referring to capacity matrices corresponding to respective origins to obtain the number of units of a product available at the respective origins at a first time and the number of units of a product available at the respective origins at a second time.

17. The system of claim 15, wherein generating a plurality of delivery objects may include determining whether the origins have enough supply of a product type to cover the demand for the same product type at a destination.

18. The system of claim 15, wherein the historical delivery plan information includes whether or not past executed delivery plans were executed on time or whether or not past executed delivery plans met predetermined key performance indicators.

19. The system of claim 18, wherein the instructions further cause the device processor to create clusters by applying a clustering algorithm to the initial delivery plan candidates to create intermediate delivery plan candidates.

20. The system of claim 19, wherein the clustering is based on spatial-temporal local and global features.
